(19) United States
(12) Patent Application Publication
(10) Pub. No.: US 2024/0141609 A1
(43) Pub. Date: May 2, 2024

(54) PEG FOR SECURING MATTING TO THE GROUND

(71) Applicant: PLATIPUS ANCHORS HOLDINGS LIMITED, Redhill (GB)

(72) Inventors: Charles AGG, Redhill (GB); Mike RUSSELL, Redhill (GB)

(73) Assignee: PLATIPUS ANCHORS HOLDINGS LIMITED, Redhill (GB)

(21) Appl. No.: 18/490,887

(22) Filed: Oct. 20, 2023

(30) Foreign Application Priority Data
Oct. 21, 2022 (GB) 2215654.1

(51) Int. Cl. E02D 5/80; E02D 29/02

(52) U.S. Cl. CPC E02D 5/801; E02D 29/0233

(57) ABSTRACT

A peg for securing matting to the ground includes a shaft extending between a first end and a second end along a longitudinal axis, and a head portion extending radially outwardly from the first end of the shaft. The head portion has a contact surface, from which the shaft extends, for contacting the matting and holding the matting against the ground. The shaft has first and second threaded portions and first and second non-threaded portions. Each threaded portion has a screw-thread and is spaced apart from an adjacent threaded portion by a non-threaded portion. The first non-threaded portion extends from the second end and the second non-threaded portion extends between the first and second threaded portions.

### CROSS-REFERENCE TO RELATED APPLICATIONS

This application claims priority under 35 U.S.C. § 119 to United Kingdom patent application GB 2215654.1, filed Oct. 21, 2022, the entire disclosure of which is incorporated herein by reference.

### BACKGROUND OF THE DISCLOSURE

### 1. Field the Disclosure

The present disclosure relates to a peg. More specifically, the present disclosure relates to a peg for securing matting to the ground. The present disclosure also relates to a kit of parts and an assembly including a peg and matting and a method of using a peg with matting.

### 2. Description of Related Art

In certain locations, it is necessary to provide erosion limitation arrangements. This can be accomplished by laying matting over the ground in that location and securing the matting to the ground. The matting can be secured to the ground using ground anchors, such as, for example, those described in patent number GB2398808B.

However, due to the spacing of the ground anchors, the matting can become loose between the anchors which would reduce its effectiveness at limiting erosion. Therefore, there is a need for securing means to secure the matting to the ground between the ground anchors and for use other situations where ground anchors are not suitable.

WO2016/020631A2 discloses one such securing means to secure the matting to the ground. However, the device disclosed in WO2016/020631A2 is difficult to use because it does not remain stable during insertion into the ground. In addition, this device may be difficult to screw into the ground and may not secure to the ground with a sufficient pull-out force. Consequently, this device may not secure the matting to the ground in an optimal manner.

Therefore, there is a need for an improved securing device for securing matting to the ground.

### SUMMARY

According to the disclosure, there is provided a peg for securing matting to the ground, the peg having a longitudinal axis and comprising:
a shaft extending between a first end and a second end along the longitudinal axis, the shaft having a length from the first end to the second end; and
a head portion extending radially outwardly from the first end of the shaft,
wherein: the head portion comprises a contact surface, from which the shaft extends, for contacting the matting and holding the matting against the ground, the contact surface extending around a periphery of the shaft;
the shaft comprises first and second threaded portions and first and second non-threaded portions, each threaded portion having a screw-thread and being spaced apart from an adjacent threaded portion by a non-threaded portion;
the first non-threaded portion extends from the second end; and
the second non-threaded portion extends between the first and second threaded portions.

The features of the peg, such as the contact surface extending around a periphery of the shaft, advantageously cause the peg to hold the matting securely against the ground. The shaft comprises at least two threaded portions, referred to herein as first and second threaded portions and at least two non-threaded portions, referred to herein as first and second non-threaded portions. Each threaded portion is spaced apart from an adjacent threaded portion by a non-threaded portion thereby causing the peg to engage separate cones of soil when the peg is inserted into the ground. This reduces the torque force required to screw the peg into the ground, while ensuring a high enough pull-out force.

Optionally, the first non-threaded portion is tapered along the longitudinal axis towards the second end. Optionally, the first non-threaded portion is tapered at an angle of between 5 and 20. Optionally, the length of the shaft is between 10 cm and 50 cm. More preferably, the length of the shaft is between 10 cm and 30 cm. Optionally, the first non-threaded portion of the shaft has a length of more than ⅛th of the length of the shaft, preferably between ⅛th and half of the length of the shaft, more preferably between ⅛th and ⅓rd of the length of the shaft, and even more preferably between ⅙th and ¼th of the length of the shaft.

Preferably, the shaft is tapered along more than ¼ of the length of the shaft, preferably along more than ⅓ of the length of the shaft, more preferably along more than ½ of the length of the shaft or along the whole of the length of the shaft. Optionally, the shaft is tapered at an angle that increases from the first end to the second end, preferably wherein the angle at which the shaft is tapered increases from the first end to the second end by between 1 and 20 degrees, preferably by between 5 and 10 degrees.

Preferably, a diameter of the head portion is more than 3 cm and preferably a diameter of the first end of the shaft is less than 2 cm. Preferably, the contact surface comprises a surface area of more than 3 cm². Optionally, the contact surface is a planar surface. The planar surface advantageously spreads the force imparted by the peg to the matting over a larger surface area. Spreading the force over a larger surface area reduces the pressure applied by the peg to the matting, and therefore reduces the risk of the peg tearing the matting.

Preferably, each of the threaded portions form the same helix. This advantageously aids the user in screwing the peg into the ground.

Optionally, each threaded portion has a length between 1/10th and 9/10th of the length of the shaft, preferably between 1/10th and ⅘th of the length of the shaft and even more preferably between 1/10th and ⅓rd of the length of the shaft.

Preferably, the second non-threaded portion extends from the first end of the shaft. In other words, the threaded portion proximal to the first end of the shaft is spaced apart from the first end of the shaft by the second non-threaded portion. This advantageously ensures that the peg does not snag the matting when it is inserted.

The peg is preferably formed of a plastic. This advantageously allows the peg to be injection moulded.

Preferably the plastic is an engineering plastic. This advantageously gives the peg increased strength. More preferably the plastic is a UV resistant or UV inhibited plastic, the plastic may be a UV resistant/inhibited engineering plastic. This advantageously ensures that the peg will not degrade when it is left outside in direct sunlight for extended periods of time in use.

Optionally, each threaded portion has a thread height of at least 2 mm, preferably 3-10 mm. The thread height may be the distance from a root to a crest of a thread. In other words, the thread height may be the radial distance from the shaft to the outer edge of the screw thread.

Preferably, the peg comprises at least one cutting edge proximal to the second end. This advantageously allows the peg to break up hard soil as it is screwed into the ground and thereby aids insertion of the peg into the ground. The at least one cutting edge may form the second end. The second end may comprise the at least one cutting edge.

Optionally, the second end is formed as a point. This advantageously ensures that the peg is stable in an upright position as it is screwed into the ground provides a point of contact which is stable during rotation, and enables ease of piercing the matting and insertion into the ground. Preferably, the head portion is configured to engage with a drive tool. This advantageously allows the peg to be used with a drive tool to aid insertion into the ground.

Optionally, an outer periphery of the head portion is configured to engage with the drive tool to secure the peg to the drive tool. The periphery of the head portion may form an interference fit with the drive tool. The drive tool may circumferentially engage with the head portion. The interference fit between the outer periphery of the head portion of the peg and the drive tool can keep the peg engaged with the drive tool even when the peg is below the drive tool. This advantageously allows the peg to be screwed into the ground using the drive tool without holding the peg in place and allows a user to screw the peg into the ground using the drive tool while the user is in a standing position.

In addition, or alternatively, the head portion may comprise peg engagement means configured to engage with the drive tool and transmit torque from the drive tool to the peg. Optionally, the peg engagement means may form a clearance fit with the drive tool.

In one embodiment, the outer periphery of the head portion is configured to form an interference fit with a cavity of the drive tool and the peg engagement means is configured to form a clearance fit with corresponding engagement means of the drive tool. In such an arrangement, the peg can be easily secured to the drive tool without precise alignment by a user, but torque can still be transmitted from the drive tool to the peg.

The peg engagement means may optionally be one or more protrusions. This advantageously also stiffens the head portion so that the head portion may comprise less material or be less likely to buckle in use.

There is also provided a kit of parts comprising the peg described above comprising the peg engagement means and a drive tool. The drive tool is configured to engage with the peg.

Optionally, the drive tool comprises a cavity for receiving the head portion of the peg. In particular, the cavity of the drive tool may be shaped to form an interference fit with the outer periphery of the head portion of the peg. The periphery of the cavity may circumferentially engage with the outer periphery of the head portion of the peg. Additionally, or alternatively, the drive tool may also comprise a drive tool engagement means configured to engage with the peg engagement means. The drive tool engagement means may be configured to form a clearance fit with the peg engagement means for transmitting torque from the drive tool to the peg.

This kit of parts can advantageously be used to easily screw the peg through the matting into the ground.

Optionally, the kit of parts further comprises a drill. The drive tool is configured to attach to the drill such that the drive tool rotates when the drill is operated. This advantageously allows the drive tool to be rotated easily.

Optionally, the kit of parts may further comprise matting.

There is also provided a kit of parts comprising matting and a plurality of the pegs as described above.

There is also provided an assembly comprising matting and a plurality of pegs the pegs as described above. Each peg is screwed into the matting at a respective location such that each peg is spaced apart from an adjacent peg.

Each peg being screwed into the matting at a respective location such that each peg is spaced apart from an adjacent peg advantageously causes the matting to be secured tightly to the ground.

Optionally, the shaft comprises two or more threaded portions and two or more non-threaded portions, each threaded portion spaced apart from an adjacent threaded portion by a non-threaded portion.

The description of the pegs above equally applies to the pegs of the assembly.

There is also provided a method of securing matting to the ground using the kit of parts comprising matting and a plurality of pegs for securing the matting to the ground described above. The method comprises placing the matting on the ground; engaging the second end of the shaft with the matting; and rotating the peg such that the screw-thread of the peg is screwed through the matting into the ground. The peg is rotated until the contact surface contacts the matting and holds the matting against the ground.

Optionally, the shaft comprises two or more threaded portions and two or more non-threaded portions, each threaded portion spaced apart from an adjacent threaded portion by a non-threaded portion.

The description of the pegs above equally applies to the pegs employed in the method.

Preferably, the method further comprises engaging a drive tool with the peg; and rotating the drive tool such that the peg is screwed through the matting into the ground.

More preferably, the method further comprises attaching the drive tool to a drill and operating the drill to rotate the drive tool.

The method may comprise engaging an outer periphery of the head portion of the peg with a cavity of the drive tool, optionally the outer periphery of the head portion of the peg and the cavity of the drive tool may form an interference fit. The drive tool, optionally a cavity within the drive tool, may circumferentially engage the head portion of the peg.

The method may further comprise engaging peg engagement means with drive tool engagement means of the drive tool such that torque may be transmitted from the drive tool to the peg due to engagement between the peg engagement means and drive tool engagement means. The peg engagement means and the drive tool engagement means may form a clearance fit.

### BRIEF DESCRIPTION OF THE FIGURES

For a better understanding of the disclosure, and to show how the same may be put into effect, reference will now be made, by way of example only, to the accompanying drawings in which:

FIGS. 1a and 1b are perspective view of a peg for securing matting to the ground;

FIG. 2 is a perspective view of part of the shaft of the peg of FIGS. 1a and 1b;

FIG. 3 is a perspective view of a kit of parts comprising the peg of FIGS. 1a and 1b and a drive tool. Only a partial view of the peg is shown in FIG. 3;

FIG. 4 is a perspective view of a kit of parts comprising a plurality of the pegs of FIGS. 1a and 1b and matting; and

FIG. 5 is a side elevation cross sectional view of an assembly containing a plurality of the pegs of FIGS. 1a and 1b and matting where the plurality of pegs are inserted through matting into the ground.

FIG. 6 is a perspective view of the assembly of FIG. 5.

FIG. 7 is a perspective view of an assembly containing a plurality of the pegs of FIGS. 1a and 1b, matting and ground anchors where the plurality of pegs and ground anchors are inserted through matting into the ground.

### DETAILED DESCRIPTION

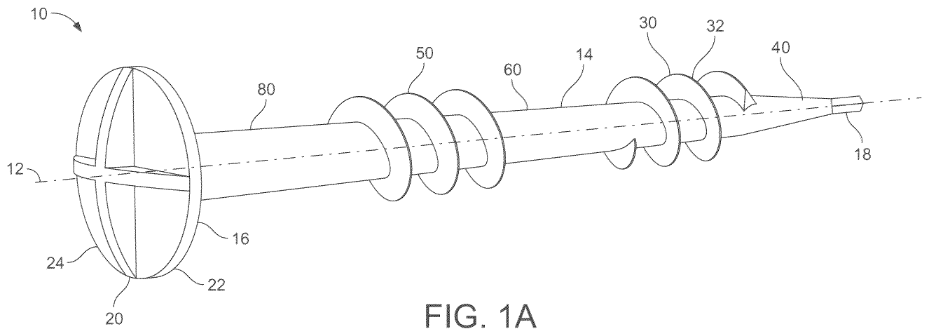

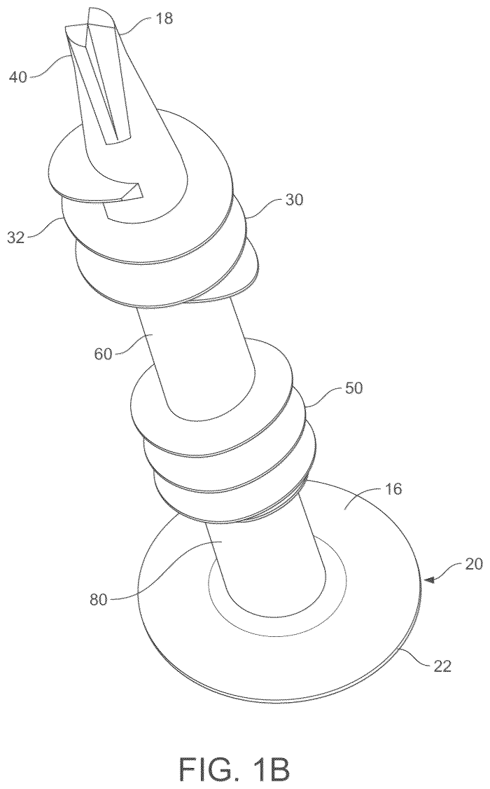

As shown in FIGS. 1a and 1b, referred to hereinafter collectively as FIG. 1, there is disclosed a peg 10 for securing matting to the ground. The peg 10 has a longitudinal axis 12. The peg 10 comprises a shaft 14 extending between a first end 16 and a second end 18 along the longitudinal axis 12. The shaft 14 has a length L measured from the first end 16 to the second end 18. The length of the shaft L is optionally between 10 cm and 50 cm, particularly between 10 cm and 30 cm. The shaft 14 has a circular cross section in the embodiment shown in FIG. 1 but alternatively shaped cross-sections are contemplated.

In this optional arrangement, the shaft 14 is tapered along the whole of the length of the shaft L. The shaft 14 optionally has a taper angle of between 0.2 and 10 degrees. The taper angle at a location along the shaft is an angle measured between the longitudinal axis 12 and a line which is a tangent to the surface of the shaft 14 at that location. In alternative arrangements, the shaft may be tapered along a part of the length of the shaft L. For example, the shaft 14 may be tapered along a part of the length of the shaft L that may be more than ¼ of the length of the shaft L or more than ⅓ of the length of the shaft L or in alternative arrangements, the shaft 14 is not tapered and so substantially cylindrical along most of its length.

The peg 10 further comprises a head portion 20 extending radially outwardly from the first end 16 of the shaft 14. The head portion 20 extends radially outwardly from the longitudinal axis 12. The head portion 20 optionally has a circular shape but other shapes are contemplated, such as a square. The diameter of the head portion 20 is optionally more than 3 cm. Preferably the diameter of the first end 16 of the shaft 14 may be less than 2 cm. The head portion 20 optionally extends radially beyond the shaft 14 by at least 0.5 cm. In some embodiments, the head portion 20 extends radially beyond the shaft 14 by more than 1 cm. The head portion 20 and shaft 14 may form a unitary body.

The head portion 20 comprises a contact surface 22, from which the shaft 14 extends, for contacting the matting 100 and holding the matting 100 against the ground 200. The contact surface 22 extends around a periphery of the shaft 14. The contact surface 22 is the lower surface of the head portion 20 that is proximal to the first end 16 of the shaft 14. The lower surface may be defined as the surface of the head portion 20 facing the shaft 14. The contact surface 22 optionally has a surface area of more than 3 cm² or more than 5 cm². The contact surface 22 is optionally a planar surface i.e. is substantially planar. The contact surface 22 optionally has an annular shape. The contact surface 22 may be configured to spread the force imparted by the peg 10 to the matting 100. The contact surface 22 can allow the peg 10 to hold the matting 100 against the ground 200 with a low pressure to avoid tearing the matting 100.

In the embodiment shown in FIG. 1, the contact surface is optionally a solid continuous surface. Alternatively, the contact surface may be a mesh or ribbed surface. By way of further alternative, the contact surface 22 may be formed as a ring of material radially spaced apart from the shaft 14 by an air gap.

The head portion 20 optionally further comprises peg engagement means 24 for engaging with a drive tool to transmit torque from the drive tool to the peg 10. Configuring the peg 10 to be used with the drive tool can aid insertion of the peg 10 into the ground 200. As shown in the illustrated embodiment, the peg engagement means 24 optionally has one or more protrusions 24. The one or more protrusions 24 are optionally formed on an upper surface of the head portion 20 (wherein the upper surface is the surface facing away from the shaft 14). The one or more protrusions 24 may protrude in the direction of perpendicular to the upper surface of the head portion 20 (i.e. parallel to the longitudinal axis 12). The one or more protrusions 24 are optionally in the shape of a cross in the embodiment of FIG. 1 and so extend in a radial direction. The one or more protrusions 24 can stiffen the head portion 20 so that the head portion 20 may comprise less material or be less likely to buckle in use. Alternatively, the peg engagement means may comprise one or more grooves in the head portion 20.

The shaft 14 comprises a first threaded portion 30. The first threaded portion 30 comprises a screw-thread 32. The first threaded portion 30 extends along a part of the length L of the shaft 14, for example. In the embodiment shown in FIG. 1, the first threaded portion optionally extends along ⅕^{th} of the length L of the shaft 14. In alternative embodiments, the first threaded portion 30 may extend along a portion of the length L of the shaft that is between ⅓^{rd} and ⅛^{th} of the length of the shaft 14, particularly between ¼^{th} and ⅙^{th} of the length of the shaft 14. The first threaded portion 30 may comprise a screw thread 32 along its entire length. The screw thread 32 may comprise a helical ridge on the outside of the shaft 14. The screw thread 32 may comprise a number of turns. The screw thread 32 may comprise at least three turns. The screw thread 32 may comprise a constant pitch, that is the distance between adjacent turns may be a constant value along the screw thread 32. The screw thread 32 and the shaft 14 may form a unitary body. Each threaded portion may have a thread height of at least 2 mm, preferably 3-10 mm. The thread height may be the distance from a root to a crest of a thread. In other words, the thread height may be the radial distance from the shaft 14 to the outer edge of the screw thread 32. The first threaded portion 30 may be configured to engage the ground 200. The first threaded portion 30 may be configured to secure the peg 10 to the ground 200 and impart a force to the matting 100 to hold it against the ground.

The shaft comprises a first non-threaded portion 40 extending from the second end 18. The non-threaded portion 40 is unthreaded and so does not have a screw thread along its length. The non-threaded portion 40 has a smooth surface. A smooth surface may be defined as a surface without a screw thread or ridges present. At least a part of the first non-threaded portion 40 is optionally tapered along the longitudinal axis 12 towards the second end 18. For example, at least a part of the first non-threaded portion 40 may be tapered at an angle of, for example, between 2 and 20 degrees, preferably between 4 and 10 degrees.

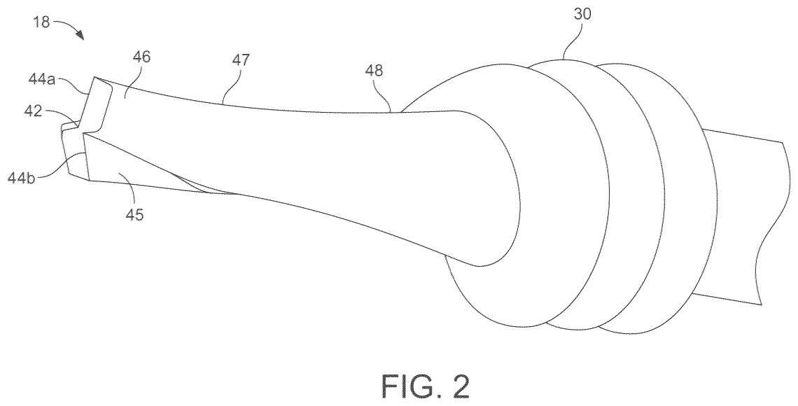

FIG. 2 shows the second end 18, the first non-threaded portion 40 and some of the first threaded portion 30 of the peg 10 in more detail. The first non-threaded portion 40 may be configured for piercing matting 100. The first non-threaded portion 40 may be configured for piercing and/or breaking up the ground 200. The first non-threaded portion 40 may be configured for keeping the peg 10 straight as the peg 10 is inserted into the ground 200.

The first non-threaded portion 40 may comprise at least one cutting edge 44a, 44b proximal to the second end 18. The cutting edge(s) 44a, 44b may also have a thickness of up to, for example 3 mm, and still function as an edge. The cutting edge(s) 44a, 44b may form the second end 18. As best shown in FIG. 2, the peg 10 optionally has first and second cutting edges 44a, 44b forming the second end 18. The cutting edges optionally meet at a point at the second end 18. As best shown in FIG. 2, the cutting edge(s) 44a, 44b optionally meet at an angle of between 170 and 100 degrees to form the second end 18. The cutting edge(s) 44a, 44b are optionally straight edges and formed by the meeting of two surfaces at an angle. The angle between the surfaces forming the cutting edges may be between 1 and 20 degrees. More specifically, each cutting edge 44a, 44b may be formed between an inner surface 45, which is optionally substantially planar/flat in the embodiment shown in FIG. 2 and an outer surface 46, which is optionally curved in the embodiment shown in FIG. 2. The inner surfaces 45 may be opposing and optionally offset from each other about the longitudinal axis, as shown in FIG. 2.

In FIG. 2, the two cutting edges 44a, 44b are optionally offset from each other about the longitudinal axis. The peg is optionally rotationally symmetrical about the longitudinal axis. In particular, the first non-threaded portion 40 optionally is rotationally symmetrical about the axis. The first non-threaded portion optionally has a rotational symmetry of order two, such that it comprises two cutting edges 44, two inner surfaces 45 and two outer surfaces 46 proximal to the second end, offset at 180 degrees from each other around the longitudinal axis 12.

As discussed above, at least a part of the first non-threaded portion 40 may be tapered. In the embodiment shown in FIG. 2, the first non-threaded portion optionally has a tapered part 48 proximal to the first non-threaded portion. A non-tapered part 47 optionally extends between the tapered part 48 and the inner and outer surfaces 45, 46 forming the cutting edges 44a, 44b. The non-tapered part 47 is optionally cylindrical.

Returning to the optional arrangement shown in FIG. 1, the shaft 14 is tapered at an angle that increases from the first end 16 to the second end 18. In other words, the shaft 14 may have a larger taper at the second end 16 than at the first end 18. Optionally, the angle at which the shaft 14 is tapered may increase from the first end 16 to the second end 18 by between 1 and 20 degrees and preferably by between 3 and 8 degrees. A taper angle may also be defined as a taper ratio.

The first non-threaded portion 40 optionally has a length of between ⅛^{th} and half of the length of the shaft L, for example, the first non-threaded portion 40 optionally has a length of between ⅛^{th} and ⅓^{rd} of the length of the shaft L. In the embodiment shown in FIG. 1, the first non-threaded portion has approximately the same length as the first threaded portion, which is between ⅙^{th} and ¼^{th} of the length of the shaft L.

In the embodiment shown in FIG. 1, the shaft 14 optionally comprises two or more threaded portions 30, 50 and two or more non-threaded portions 40, 60. In other words, the shaft 14 may comprise the first threaded portion 30, a second threaded portion 50, the first non-threaded portion 40 and a second non-threaded portion 60. Each threaded portion 30, 50 is spaced apart from an adjacent threaded portion 30, 50 by a non-threaded portion 60. Each threaded portion 30, 50 may have features described above in relation to the first threaded portion 30. Each non-threaded portion 40, 60 may comprise some features described above in relation to the first non-threaded portion 40 such as not comprising a screw thread or comprising a smooth outer surface. Each threaded portion 30, 50 may be configured to engage a separate cone of soil when the peg 10 is inserted in the ground 200. The threaded portions 30, 50 may be spaced apart along the longitudinal axis 12. In other words, the first threaded portion 30 may be spaced apart from the second threaded portion 50 by the second non-threaded portion 60.

Each of the threaded portions 30, 50 may form the same helix. Forming the same helix may mean that the circumferential location at which one threaded portion 30 ends is the same circumferential location a second threaded portion 50 begins, despite the second threaded portion 50 starting at a lower axial location than the end of the first threaded portion 30.

Each threaded portion optionally has a length between 1/10^{th} and 9/10^{th} of the length of the shaft, particularly between 1/10^{th} and ⅘^{th} of the length of the shaft. In the specific embodiment shown in FIG. 1, each threaded portion has a length of between ⅙^{th} and ¼^{th} the length of the shaft. The length of at least one of the threaded portions 30, 50 may be equal to the length of at least one the lengths of the non-threaded portions 40, 60. In the specific embodiment shown in FIG. 1, the length of each of the threaded portions 30, 50 may be equal to each other and to the length of each of the non-threaded portions 60. In other words, a 1:1 relationship may exist between the length of each of the threaded portions 30, 50 and each of the non-threaded portion 60.

The threaded portion 50 proximal to the first end of the shaft 14 may be spaced apart from the first end 16 of the shaft 14 by a non-threaded portion 80. In particular, the second threaded portion 50 may be spaced apart from the first end 16 of the shaft 14 by a third non-threaded portion 80. The third non-threaded portion 80 may be configured such that the peg 10 does not snag or get caught on the matting 100 when the peg 10 is inserted through matting 100 into the ground 200. The third non-threaded portion 80 may comprise some features described above in relation to the first non-threaded portion 40 such as not comprising a screw thread or comprising a smooth outer surface. The third non-threaded portion 80 may comprise a length equal to the length of at least one of the threaded portions 30, 50.

The peg 10 may be formed of a plastic. Preferably the peg 10 may be of an engineering plastic, more preferably of a UV inhibited engineering plastic. The UV inhibited engineering plastic may also be describes as a UV-resistant engineering plastic.

Alternatively, the peg 10 could be formed of metal or another material and have the same effect, but plastic is preferable.

The peg 10 may be manufactured by injection moulding. Alternatively, the peg 10 may be manufactured by additive manufacture, or tooling.

FIG. 2 shows a kit of parts comprising a peg 10 as described above and a drive tool 100.

The drive tool 100 optionally has a cavity 131 configured to receive the head portion 20 of the peg 10 to secure the peg 10 to the drive tool 100. In particular, the cavity 131 has a smaller diameter than the diameter of the head portion 20 of the peg 10 such that the outer periphery of the head portion 20 of the peg 10 and the cavity 101 form an interference fit. The cavity 131 optionally has drive tool engagement means 124 configured to engage with the peg engagement means 24 for transmitting torque from the drive tool 100 to the peg 10. Optionally, the drive tool engagement means 124 and the peg engagement means 24 form a clearance fit. In this arrangement, a user can easily secure the peg 10 to the drive tool 100 using the interference fit between the periphery of the head portion and the cavity 131 of the drive tool 100 without precise alignment. The user can transmit torque from the drive tool 100 to the peg 10 by rotating the drive tool 100 due to the clearance fit between the peg engagement means 24 and the drive tool engagement means 124. By employing a clearance fit between the peg engagement means 24 and the drive tool engagement means 124, a less precise alignment is required compared to, for example, an interference fit. Engaging the drive tool engagement means 124 with the peg engagement means 24 can allow a user to easily rotate the peg 10 by rotating the drive tool 100. This can aid a user in inserting the peg 10 into matting and/or into the ground. The peg engagement means 24 are complementary to the drive tool engagement means 124.

An exemplary embodiment of the drive tool 100 is shown in FIG. 2. In this exemplary embodiment shown, the drive tool 100 comprises a body 130 having a cavity 131 formed therein and a drive tool shaft 140. The body 130 in FIG. 2 has an outer periphery that is curved. In the arrangement shown, the cavity has a diameter defined by its outer periphery that is smaller than the outer periphery of the head portion 20 of the peg 10 such that the outer periphery of the cavity and the outer periphery of the head portion form an interference fit to secure the peg 10 to the drive tool 100. The interference fit can provide increased friction which can keep a peg 10 engaged with the drive tool 100 even when the peg 10 is lower than the drive tool 100. This can aid a user when inserting a peg 10 into the ground as they would not simultaneously have to hold the peg 10 and drive tool 100 in position and can instead just hold the drive tool 100.

In the arrangement shown, the drive tool engagement means 124 are optionally grooves 124 formed within the cavity 131 of the body. The grooves 124 optionally take the shape of a cross but other shapes are contemplated. In an embodiment where the drive tool engagement means 124 comprises grooves, such as that shown in FIG. 2, the peg engagement means 24 may comprise protrusions. In the embodiment shown in FIG. 2, the protrusions optionally take the shape of a cross. Peg engagement means 24 having the protrusions 24 is advantageous because the protrusions 24 can stiffen the head portion 20 so that the head portion 20 may comprise less material or be less likely to buckle in use. The peg engagement means 24 and the drive tool engagement means 124 are configured to form a clearance fit such that exact alignment is not required for engagement. Torque is transmitted from the drive tool 100 to the peg 20 via the engaged peg engagement means 24 and drive tool engagement means 124. The clearance fit may occur when the peg engagement means 24 is engaged with the drive tool engagement means 124. For example, if the peg engagement means 24 comprises protrusions 24 and the drive tool engagement means 124 comprises grooves 124, the clearance fit can be formed by ensuring the protrusions 24 have a smaller width than the grooves 124.

As shown in FIG. 2, the drive tool shaft 140 may be cylindrical and may extend from an opposite side of the body 130 to the cavity 131. The drive tool shaft 140 may be of a smaller diameter than the body 130. The drive tool shaft 140 and body 130 optionally form a unitary body and may be formed of metal by casting or tooling among other methods.

The kit of parts may further comprise a drill. The drive tool 100 may be configured to attach to the drill such that the drive tool 100 rotates when the drill is operated. The drive tool shaft 140 may be configured such that it is engageable with the drill. Using a drill in combination with the drive tool 100 and peg 10 can aid a user when inserting a peg 10 into the ground since it provides an easy method for rotating the peg 10.

Alternatively, the kit of parts may further comprise a bit and brace. The bit and brace comprise a crank-shaped turning device that grips and rotates the drive tool 100. In another embodiment, the drive tool 100 may further comprise a crank shaped shaft extending from the drive tool shaft 140.

The kit of parts may further comprise matting. The drive tool 100 can be used to rotate the peg 10 as it is inserted through the matting.

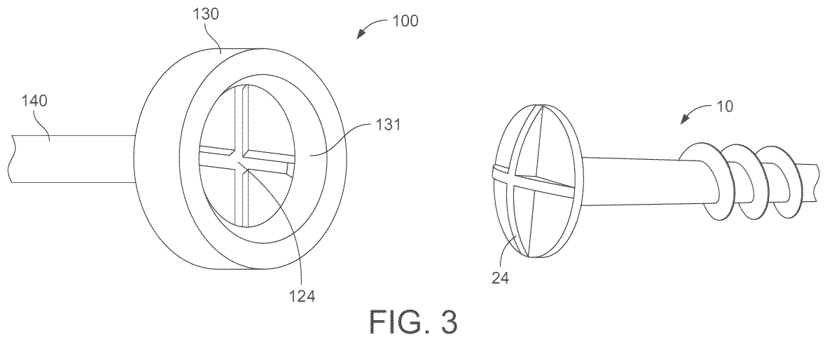

FIG. 3 shows a kit of parts comprising matting 200 and a plurality of pegs 10 for securing the matting 200 to the ground. The matting 200 may be geotextile matts. Alternatively, the matting 200 may be any material configured to be secured to the ground. The matting 200 may be of a woven structure. The matting 200 may be formed of fibers.

The ground may be substantially formed of, for example, soil and/or clay and/or vegetation.

Each of the plurality of pegs 10 are optionally configured as shown in FIG. 1. Although the shaft 14 of the peg 10 is shown as having two threaded portions 30, 50 and two non-threaded portions 40, 60 the shaft 14 may instead have only one threaded portion 30 and one non-threaded portion 40 wherein the non-threaded portion 40 is proximal the second end 18. By way of further example, the shaft 14 may comprise more than two threaded portions 30, 50 and more than two non-threaded portions 40, 60, each threaded portion 30, 50 spaced apart from an adjacent threaded portion 30, 50 by a non-threaded portion 60. The pegs may further comprise any of the optional features described in connection with the peg 10 of FIG. 1 above.

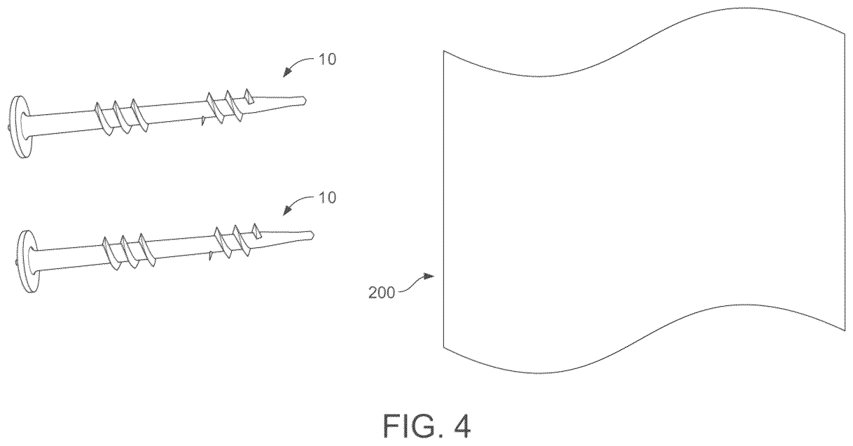

FIG. 4 shows a kit of parts comprising matting 200 and a plurality of pegs 10 for securing the matting 200 to the ground 300.

Each of the plurality of pegs 10 are optionally configured as shown in FIG. 1. Although the shaft 14 of the peg 10 is shown as having two threaded portions 30, 50 and two non-threaded portions 40, 60 the shaft 14 may have only one threaded portion 30 and one non-threaded portion 40 wherein the non-threaded portion 40 is proximal the second end 18. By way of further example, the shaft 14 may comprise more than two threaded portions 30, 50 and more than two non-threaded portions 40, 60, each threaded portion 30, 50 spaced apart from an adjacent threaded portion 30, 50 by a non-threaded portion 60. The pegs may further comprise any of the optional features described in connection with the peg 10 of FIG. 1 above.

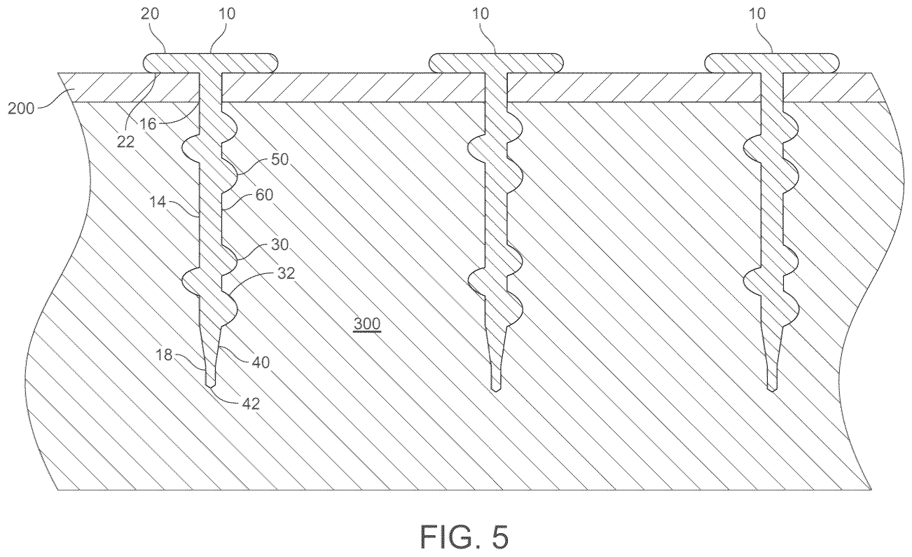

Each peg 10 is screwed into the matting 200 at a respective location such that each peg 10 is spaced apart from an adjacent peg 10. Each peg 10 has all the features described in connection with the peg 10 of the kit of parts described above in relation to FIG. 3. FIGS. 5, 6 and 7 each show an assembly comprising matting 200 and a plurality of the pegs 10 shown in FIG. 1 where the pegs 10 are screwed through the matting 200 into the ground 300 to secure the matting 200 to the ground 300.

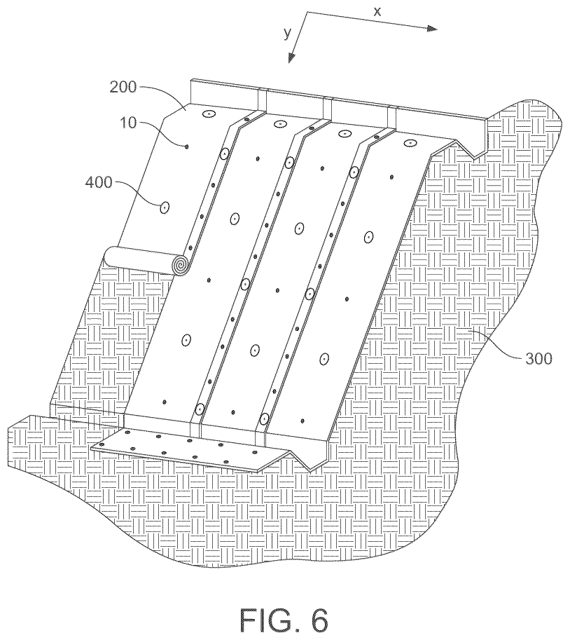

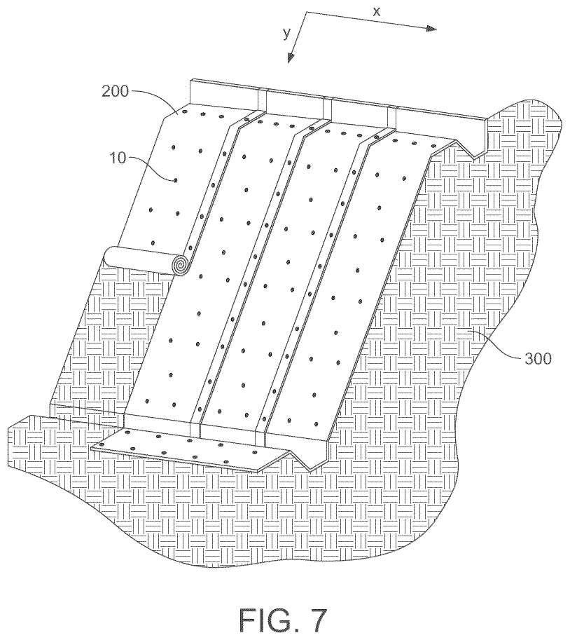

The assembly of FIG. 7 optionally further comprises ground anchors 400 screwed into the matting to further secure the matting 200 to the ground 300 whereas the assembly of FIGS. 5 and 6 only uses pegs 10 to secure the matting to the ground 300.

FIGS. 6 and 7 are perspective views of the assembly whereas FIG. 5 is a side elevation cross sectional view.

Each peg 10 may be spaced apart from adjacent pegs 10 by between 0.2 and 3 m. As shown in FIG. 6, when only pegs 10 are used to secure the matting 200 to the ground 300, each peg 10 may be spaced apart from the adjacent pegs 10 by between 0.2 and 1.5 m, preferably between 0.5 and 1.2 m. As shown in FIG. 5, when both pegs and anchors are used to secure matting 200 to the ground 300, ground anchors 400 may be positioned between adjacent pegs 10 and the spacing between adjacent pegs 10 and ground anchors 400 may be, for example, between 0.1 and 2.5 m, preferably between 0.25 and 2 m. In particular, in the direction across a slope of ground, in the x direction shown in FIG. 6, the spacing between a ground anchor 400 and an adjacent peg 10 may be approximately 0.2-1.5 m, preferably 0.25-1 m. In the direction down a slope of ground, in the y direction shown in FIG. 6, the spacing between an adjacent ground anchor 400 and an adjacent peg 10 may be, for example 0.2-2.5 m, preferably 0.5-2 m.

Exemplary ground anchors 400 that may be used to secure matting 200 to the ground 300 are described in patent number GB2398808A,

The spacing between adjacent pegs 10 in an arrangement using only pegs 10 to secure the matting 2200 to the ground 300 is smaller than the spacing between a peg 10 and an adjacent ground anchor 400 when ground anchors are used between pegs 10. In either arrangement, the plurality of pegs 10 and (if present) ground anchors 400.

keep the matting 200 tight against the ground 300. It is beneficial for the pegs 10 to hold the matting 200 tight against the ground 300 because otherwise vegetation grows from the ground 300 underneath the matting 200 creating flow paths underneath the matting 200.

A method using the kit of parts of FIG. 3 to secure matting 200 to the ground 300 to form the assembly shown in FIG. 4 comprises the following steps. The matting 200 is placed on the ground 300. The second end 18 of the shaft 14 is engaged with the matting 200. The peg 10 is rotated such that the screw-thread 32 of the peg 10 is screwed through the matting 200 into the ground 300. The peg 10 is rotated until the contact surface 22 contacts the matting 200 and holds the matting 200 against the ground 300.

The method may optionally further comprise, as a first step, engaging the peg 10 with the drive tool 100 to secure the peg 10 to the drive tool 100. The method may comprise transmitting torque from the drive tool to the peg 10 to rotate the peg 10. More specifically, the method may comprise engaging the outer periphery of the head portion 20 of the peg 10 with the cavity 131 within the body 130 of the drive tool 100 to secure the peg 10 to the drive tool and then engaging the peg engagement means 24 with the drive tool engagement means 124 within the cavity 131 to transmit torque from the drive tool 100 to the peg 10.

If the shaft 14 comprises two or more threaded portions 30, 50 and two or more non-threaded portions 40, 60, each threaded portion spaced 30, 50 apart from an adjacent threaded portion 30, 50 by a non-threaded portion 60, the method may further comprise screwing the first threaded portion 30 through the matting 200 into the ground 300 and then screwing the second threaded portion 50 through the matting 200 into the ground 300. The non-threaded portion 60 in between the two threaded portions 30, 50 can reduce the effort needed for a user to screw the peg 10 through the matting 200 into the ground 300 compared to a peg threaded along the entire length of the shaft.

According to soil mechanics, each threaded portion 30, 50 engages the surrounding soil when the peg 10 is screwed into the ground 300. When multiple threaded portions 30, 50 are separated by a non-threaded portion 60, the failure surface in the soil is approximately cylindrical and contained between the threaded portion 30, 50. The shear strength along the shaft length is calculated from the shear strength of the surrounding soil. The failure surface above the top threaded portion 50, is a truncated cone extending to the ground surface. The central angle of the truncated cone is approximately equal to the soil friction angle.

As discussed in Das, B. and Shukla, S. (2013). Earth Anchors. Second ed. USA: J. Ross Publishing, Inc., the pull-out force of the peg can be estimated according to the theory by Mitsch and Clemence (1985), or: Qᵤ=Qₚ+Q_{f}

Qₚ=Bearing resistance of the truncated cone of soil extending to the ground surface above the top threaded portion 50.

Q_{f}=Frictional resistance derived at the interface of the soil including and between threaded portion 30, 50.

The magnitude of Qₚ can be given as:
Free Draining:

$${Q}_{p} = πγ {K}_{u} tan θ [ {cos}^{2} ( \frac{θ}{2} ) ] [ \frac{{D}_{1} {H}_{1}^{2}}{2} + \frac{{H}_{1}^{2} tan ( \frac{θ}{2} )}{3} ] + {W}_{s}$$

Wherein:
γ=Unit Weight
θ=Soil Friction Angle
Kᵤ=Coefficient of lateral earth pressure uplift
Wₛ=Weight of the soil in the failure zone
D₁=Diameter of the top threaded portion 50
H₁=Distance between ground surface and the top of the threaded portion 50

Qₚ=A(CᵤF_{c}γH₁) Cohesive:
Wherein:
A=Area of top threaded portion 50
F_{c}=Breakout factor
Cᵤ=Undrained shear strength

The frictional resistance derived at the interface of the soil between and including the threaded portion 30, 50 can be given as:
Free Draining:

$${Q}_{f} = \frac{π}{2} {D}_{a} γ ( {H}_{n}^{2} - {H}_{1}^{2} ) {K}_{u} tan θ$$

Wherein:
Dₐ=Average threaded portion 30, 50 diameter
Hₙ=Distance between the bottom of the threaded portion 30 and the ground surface
Cohesive:

$${Q}_{f} = π ( \frac{{D}_{1} + {D}_{n}}{2} ) ( {H}_{n} - {H}_{1} ) {C}_{u}$$

Wherein:
Dₙ=Diameter of the bottom threaded portion 30

Including multiple threaded portions 30, 50 separated by a non-threaded portion 60, rather than a threaded portion extending along the entire shaft length L, will significantly reduce the torque force required to screw the peg 10 into the ground 300, while ensuring a high enough pull-out force. The pull-out force is a measure of how much force is needed to pull the peg 10 linearly out of the ground without a screwing action. When the head portion 20 of the peg 10 further comprises peg engagement means 24, the method may further comprise engaging the drive tool engagement means 124 of a drive tool 100 with the peg engagement means 24 and rotating the drive tool 100 such that the peg 10 is screwed through the matting 200 into the ground 300. In addition, the method may further comprise attaching the drive tool 100 to a drill and operating the drill to rotate the drive tool 100. Alternatively, the drive tool 100 may be used with a bit and brace in which case the drive tool is rotated by turning the bit and brace.

What is claimed is:

1. A peg for securing matting to the ground, the peg having a longitudinal axis and comprising:
a shaft extending between a first end and a second end along the longitudinal axis, the shaft having a length from the first end to the second end; and
a head portion extending radially outwardly from the first end of the shaft, wherein:
the head portion comprises a contact surface, from which the shaft extends, for contacting the matting and holding the matting against the ground, the contact surface extending around a periphery of the shaft;
the shaft comprises first and second threaded portions and first and second non-threaded portions, each threaded portion having a screw-thread and being spaced apart from an adjacent threaded portion by a non-threaded portion;
the first non-threaded portion extends from the second end; and
the second non-threaded portion extends between the first and second threaded portions.

2. The peg of claim 1, wherein at least part of the first non-threaded portion is tapered along the longitudinal axis at an angle of between 0.2 and 15 degrees.

3. The peg of claim 1, wherein the length of the shaft is between 10 cm and 50 cm.

4. The peg of claim 1, wherein the first non-threaded portion of the shaft has a length of more than ⅛th of the length of the shaft.

5. The peg of claim 1, wherein the shaft is tapered along more than ¼ of the length of the shaft.

6. The peg of claim 1, wherein the shaft is tapered at an angle that increases from the first end to the second end by between 1 and 20 degrees.

7. The peg of claim 1, wherein the head portion has a diameter that is more than 3 cm, and wherein the first end of the shaft has a diameter that is less than 2 cm.

8. The peg of claim 1, wherein the contact surface comprises a surface area of more than 3 cm².

9. The peg of claim 1, wherein the contact surface is a planar surface.

10. The peg of claim 1, wherein each of the threaded portions form the same helix.

11. The peg of claim 1, wherein each threaded portion has a length between 1/10th and 9/10th of the length of the shaft.

12. The peg of claim 1, further comprising a third non-threaded portion that extends from the first end of the shaft.

13. The peg of claim 1, wherein the peg is formed of a plastic.

14. The peg of claim 1, wherein each threaded portion has a thread height of at least 2 mm.

15. The peg of claim 1, wherein the first non-threaded portion comprises at least one cutting edge proximal to the second end.

16. The peg of claim 1, wherein the second end is formed as a point.

17. The peg of claim 1, wherein the head portion comprises peg engagement means for engaging with a drive tool.

18. The peg of claim 17, wherein the peg engagement means comprises one or more protrusions.

19. A kit of parts comprising:
the peg of claim 17; and
wherein the drive tool comprises a drive tool engagement means configured to engage with the peg engagement means.

20. The kit of parts of claim 19, wherein the peg engagement means and the drive tool engagement means are configured so that the peg engagement means and the drive tool engagement means form a clearance fit.

21. The kit of parts of claim 19, wherein the drive tool comprises a cavity configured to circumferentially engage with the head portion of the peg, where the cavity and the head portion form an interference fit.

22. The kit of parts of claim 20, further comprising a drill, wherein the drive tool is configured to attach to the drill so that the drive tool rotates when the drill is operated.

23. The kit of parts of claim 20, further comprising matting.

24. A kit of parts comprising:
matting; and
a plurality of the pegs of claim 1.

25. An assembly comprising:
matting; and
a plurality of the pegs of claim 1,
wherein each peg is screwed into the matting at a respective location so that each peg is spaced apart from an adjacent peg.

26. A method of securing matting to the ground using the kit of parts of claim 24,
wherein the method comprises:
placing the matting on the ground;
engaging the second end of the shaft with the matting; and
rotating the peg so that the screw-thread of the peg is screwed through the matting into the ground,
wherein the peg is rotated until the contact surface contacts the matting and holds the matting against the ground.

27. The method of claim 26, wherein the head portion of the peg further comprises peg engagement means, wherein the method further comprises:
engaging a drive tool with the peg; and
rotating the drive tool so that the peg is screwed through the matting into the ground.

28. The method of claim 27, wherein the method further comprises:
attaching the drive tool to a drill; and
operating the drill to rotate the drive tool.
